(19) United States
(12) Patent Application Publication
(10) Pub. No.: US 2013/0293825 A1
(43) Pub. Date: Nov. 7, 2013

(54) ELECTROCHROMIC MATERIALS AND OPTICAL SYSTEMS EMPLOYING THE SAME

(71) Applicant: PixelOptics, Inc., (US)

(72) Inventors: Anita Trajkovska, Christiansburg, VA (US); Amitava Gupta, Roanoke, VA (US); William Kokonaski, Gig Harbor, WA (US); Ronald D. Blum, Roanoke, VA (US)

(73) Assignee: PixelOptics, Inc., Roanoke, VA (US)

(21) Appl. No.: 13/849,216

(22) Filed: Mar. 22, 2013

Related U.S. Application Data
(60) Provisional application No. 61/615,621, filed on Mar. 26, 2012.
(60) Provisional application No. 61/668,113, filed on Jul. 5, 2012.
(60) Provisional application No. 61/694,798, filed on Aug. 30, 2012.

(51) Int. Cl. G02C 7/10; G02F 1/15

(52) U.S. Cl. CPC G02C 7/101; G02F 1/15; G02F 1/1523
USPC 351/44; 359/265; 156/60

(57) ABSTRACT

The present invention relates generally to electrochromic materials and their use. In some embodiments, the invention relates to electrochromic materials for use on an optical substrate, such as a lens, a semi-finished lens blank, and the like.

### CROSS-REFERENCE TO RELATED APPLICATIONS

The present application claims the benefit of priority to U.S. Provisional Patent Application Nos. 61/615,621, filed Mar. 26, 2012; 61/668,113, filed Jul. 5, 2012; and 61/694,798, filed Aug. 30, 2012. Each of these applications is hereby incorporated by reference as though each were fully set forth herein in their entirety.

### FIELD OF THE INVENTION

The present invention relates generally to electro-chromic materials and their use. In some embodiments, the invention relates to electrochromic materials for use on an optical substrate, such as a lens, a semi-finished lens blank, and the like.

### BACKGROUND

Electrochromic coatings can be used in eyeglass lenses to provide certain benefits, including the blocking of certain wavelengths of visible or ultraviolet light. While such benefits can be achieved to a degree using photochromic materials, but photochromic materials have certain disadvantages with respect to electrochromic materials. For example, electrochromic materials can be activated and deactivated when desired, whereas photochromic materials simply respond to an external stimulus, such as the degree of ambient illumination. Nevertheless, no commercially successful electrochromic eyeglasses have appeared on the market.

Until now, electrochromic eyeglass lenses have suffered from certain limitations. These include: the inability to block light across the visible spectrum in a cosmetically pleasing manner; the inability to provide a range of contrast or blocking that is expected by consumers; poor environmental stability and short material life cycles; lack of a frame-independent manufacturing process; and the difficulty of supplying the requisite electrical power to the electrochromic material in the lenses.

There is therefore a need to provide novel electrochromic materials that can at least partially solve some of these problems. The materials, apparatuses, and methods described herein are provided so as to address one or more of the above problems that have led to the slow development of commercially viable electrochromic eyeglass lenses.

### SUMMARY OF THE INVENTION

In at least one aspect, the invention provides an electrochromic optical system, comprising: an optical substrate; and an electrochromic stack disposed on the optical substrate, wherein the electrochromic stack comprises at least five ceramic layers disposed successively on each other; wherein each of the at least five layers has a thickness of 5 to 200 nm, and at least one of the at least five ceramic layers comprises a nanostructured material.

In another aspect, the invention provides a pair of spectacles comprising: a frame; and a first lens and a second lens, each of which is disposed in the frame; wherein one or both of the first lens or second lens is an electrochromic optical system, as described above.

In another aspect, the invention provides a method of disposing one or more electrochromic layers on an optical substrate, comprising: providing an optical substrate and a glass substrate, the glass substrate having one or more electro-chromic layers disposed on a first surface; and securing the glass substrate to the optical substrate, such that the first surface of the glass substrate faces the optical substrate; wherein the securing step comprises adhering the glass substrate to the optical substrate using an adhesive layer, the adhesive layer having an index of refraction matching that of the optical substrate.

In another aspect, the invention provides a hybrid electro-chromic film, comprising a nanostructured inorganic film, the film comprising an enhancer compound; wherein the nanostructured inorganic film comprises a metal oxide; and wherein the enhancer compound is a viologen, a conductive polymer, a metal coordination complex, or Prussian blue.

Further aspects and embodiments of the invention are provided in the detailed description that follows and in the accompanying figures.

### BRIEF DESCRIPTION OF DRAWINGS

The application includes the following figures. These figures depicts certain illustrative embodiments of various aspects of the invention. In some instances, the figures do not necessarily provide a proportional illustration of an actual embodiment of the invention, but may emphasize certain features for purposes of illustration. The figures are not intended to limit the scope of the claimed subject matter apart from an express indication to the contrary.

FIG. 1 depicts an electrochromic optical system of one embodiment of the invention.

FIG. 2 depicts an electrochromic optical system of one embodiment of the invention.

FIG. 3 depicts an electrochromic optical system of one embodiment of the invention.

FIG. 4 depicts an electrochromic optical system of one embodiment of the invention.

FIG. 5 depicts an electrochromic optical system of one embodiment of the invention.

FIG. 6 depicts a flow chart depicting a method of one embodiment of the invention.

FIG. 7 depicts an optical system made by a method according to one embodiment of the invention.

FIG. 8 depicts an optical system made by a method according to one embodiment of the invention.

FIG. 9 depicts an optical system made by a method according to one embodiment of the invention.

FIG. 10 depicts an electrochromic stack according to one embodiment of the invention.

FIG. 11 depicts an optical system according to one embodiment of the invention.

### DETAILED DESCRIPTION

The following description recites various aspects and embodiments of the present invention. No particular embodiment is intended to define the scope of the invention. Rather, the embodiments merely provide non-limiting examples various compositions, apparatuses, and methods that are at least included within the scope of the invention. The description is to be read from the perspective of one of ordinary skill in the art; therefore, information well known to the skilled artisan is not necessarily included.

As used herein, the articles “a,” “an,” and “the” include plural referents, unless expressly and unequivocally disclaimed.

As used herein, the conjunction “or” does not imply a disjunctive set. Thus, the phrase “A or B is present” includes each of the following scenarios: (a) A is present and B is not present; (b) A is not present and B is present; and (c) A and B are both present. Thus, the term “or” does not imply an either/or situation, unless expressly indicated.

As used herein, the term “comprise,” “comprises,” or “comprising” implies an open set, such that other elements can be present in addition to those expressly recited.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in the following specification are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

### Electrochromic Optical System Having Electrochromic Stack

In at least one aspect, the invention provides an electrochromic optical system, comprising: an optical substrate; and an electrochromic stack disposed on the optical substrate, wherein the electrochromic stack comprises at least five ceramic layers disposed on each other; wherein at least one of the at least five ceramic layers comprises a nanostructured material.

The electrochromic optical system comprises an optical substrate. As used herein, the term “optical substrate” refers to any substrate suitable for use as a lens or lens blank, or suitable for being formed into a lens or lens blank. In general, the optical substrate is a transparent material, meaning that it transmits at least 75%, or at least 80%, or at least 85%, or at least 90%, or at least 95%, or at least 97%, or at least 99% of visible light. The invention is not limited to any particular material, so long as the material is suitable for use as an optical substrate. Suitable materials include, but are not limited to, glass, quartz, or a polymeric material, such as polycarbonate. The material can have any index of refraction suitable for use in optical applications. The substrate may also include other coatings or films, as are well known in the field to which the invention is directed.

In some embodiments, the optical substrate is a lens, such as a lens for use in a pair of spectacles. As used herein, a “lens” is any device or portion of a device that causes light to converge or diverge (i.e., a lens is capable of focusing light). A lens may be refractive or diffractive, or a combination thereof. A lens may be concave, convex, or planar on one or both surfaces. A lens may be spherical, cylindrical, prismatic, or a combination thereof. A lens may be made of optical glass, plastic, thermoplastic resins, thermoset resins, a composite of glass and resin, or a composite of different optical grade resins or plastics. It should be pointed out that within the optical industry a device can be referred to as a lens even if it has zero optical power (known as plano or no optical power). In this cases, the lens can be referred to as a “plano lens.” A lens may be either conventional or non-conventional. A conventional lens corrects for conventional errors of the eye including lower order aberrations such as myopia, hyperopia, presbyopia, and regular astigmatism. A non-conventional lens corrects for non-conventional errors of the eye including higher order aberrations that can be caused by ocular layer irregularities or abnormalities. The lens may be a single focus lens or a multifocal lens such as a Progressive Addition Lens or a bifocal or trifocal lens.

In some other embodiments, the optical substrate is a semi-finished lens blank. As used herein, a “semi-finished lens blank” refers to structure having a finished outer surface, i.e., an outer surface suitable for use as one surface of a lens, and an opposing unfinished outer surface, i.e., an outer surface that is not (or not yet) suitable for use as one surface of a lens.

In certain embodiments of the invention, an electrochromic stack is disposed on the optical substrate. In some embodiments, the electrochromic stack is disposed directly on the optical substrate, meaning that it makes direct contact with the surface (e.g., finished surface) of the optical substrate. In some other embodiments, the electrochromic stack is disposed indirectly on the optical substrate, meaning one or more coatings, films, or other layers are disposed between the electrochromic stack and surface (e.g., finished surface) of the optical substrate.

As used herein, “electrochromic stack” refers to a multi-layer structure exhibiting electrochromic properties, meaning that it reversibly changes color upon the application of an electric potential, or reversible changes color upon changing the magnitude of the electric potential applied. In some embodiments, the electrochromic stack is a structure that is transparent when no electric potential is applied to the stack, meaning that it transmits at least 75%, or at least 80%, or at least 85%, or at least 90%, or at least 95%, or at least 97%, or at least 99% of visible light. In some embodiments, the electrochromic stack is a structure that, when an electric potential is applied, blocks at least 10%, or at least 20%, or at least 30%, or at least 40%, or at least 50%, or at least 60%, or at least 70% of visible light. In some embodiments, the blocking is substantially uniform across the visible electromagnetic spectrum, while in some other embodiments it is not.

The electrochromic stack comprises at least 5 ceramic layers. In some embodiments, the electrochromic stack comprises 5, or 6, or 7, or 8, or 9, or 10, or 11, or 12, or more than 12 ceramic layers. In some embodiments, the ceramic layers are disposed successively upon each other, such that there are no intervening layers. In some other embodiments, the electrochromic stack can include one or more (e.g., up to 5) non-ceramic layers disposed between the ceramic layers. In some embodiments, the non-ceramic layers are all composed of solid materials or semi-solid materials, such as glasses. In such embodiments, the non-ceramic materials can be metallic layers, such as gold, and the like.

The ceramic and non-ceramic materials used in the electrochromic stack need not be pure materials. Any material can include, for example, dopants, which may be optionally present in suitable amounts, for example, up to about 5 weight percent. The materials layers can also include certain materials that are absorbed or adsorbed into the material. In addition, the material layers can contain a combination of materials, such as a combination of two ceramic materials. In such combination layers, the layers can, in some embodiments, display a gradient, such that the top of the layer has a higher concentration of one of the combined materials, while the bottom of the layer has a higher concentration of another of the combined materials.

The invention is not limited to any particular ceramic materials. In some embodiments, the ceramic layers in the electrochromic stack are metal oxides. Suitable metal oxides include, but are not limited to, oxides of silicon, chromium, molybdenum, tungsten, cobalt, tantalum, gadolinium, indium, tin, nickel, iridium, or any combination thereof. The ceramic layers (and any non-ceramic layers) can have any suitable thickness. In some embodiments, the layers have a thickness of from 5 to 1000 nm, or from 5 to 500 nm, or from 5 to 200 nm, or from 5 to 150 nm, or from 5 to 100 nm, or from 10 to 1000 nm, or from 10 to 500 nm, or from 10 to 200 nm, or from 10 to 150 nm, or from 10 to 100 nm. In the multi-layer stack, the individual layers in the stack need not have the same thickness of other layers in the stack. In some embodiments, however, all of the layers in the stack have substantially the same thickness, meaning that their thicknesses relative to each other are no more than 25%, or no more than 20%, or no more than 15%, or no more than 10% different, based on the thickness of the least thick of the layers in the stack.

The layers in the stack can be deposited by any suitable means. These include but are not limited to spin-coating, dip-coating, knife-coating, spray coating, dye-slot coating, magnetron- or RF-sputtering, e-beam or thermal evaporation, layer-by-layer assembly, etc. (which are among those coating methods, in general, for both organic and inorganic materials). In some embodiments, at least one of the layers in the electrochromic stack, e.g., at least one of the ceramic layers, is deposited by a sol-gel process.

In some embodiments of the invention, at least one of the layers in the stack comprises a nanostructured material. As used herein, the term “nanostructured material” means a material having a grain structure, having grains with a grain size of from 1 to 50 nm, or from 1 to 25 nm. The nanostructured material can be formed by any suitable means. In some embodiments, the nanostructured material is formed by a sol-gel process. The nanostructured material can be composed of any suitable material. In some embodiments, the nanostructured material is an oxide of tungsten, nickel, iridium, molybdenum, or a combination thereof. In some embodiments, the nanostructured material is an oxide of tungsten, nickel, or a combination thereof. In some embodiments, the nanostructured material comprises a tungsten oxide and nickel oxide.

In some embodiments, the nanostructured material is also a nanoporous material, meaning that the material has physical pores formed into the material, where the pores have a pore size of from 1 to 50 nm, or from 1 to 25 nm.

In some embodiments the nanostructured layer can be formed by layer-by-layer assembly process. For instance, nanoparticles of metal oxides with a specific surface modification or with appropriate binders can be deposited on a substrate via electrostatic molecular assembly.

The nanostructured material can be formed during the coating/deposition method or with a post-deposition step. As an example, glancing angle deposition (GLAD) and pulsed laser pyrolysis can yield a nanostructured metal oxide layer.

The layers within the stack can be arranged in any suitable manner, according to the knowledge of those of skill in the art. In some embodiments, the electrochromic stack at least comprises: a first layer composed of nickel oxide; a second layer composed of a combination of nickel oxide and tungsten oxide, and which is disposed on the first layer; and a third layer composed of tungsten oxide, which is disposed on the second layer. In some embodiments, at least one of the first layer, the second layer, or the third layer comprises a nanostructured material. In some embodiments, the second layer comprises a nanostructured material. In some embodiments, the second layer displays a gradient in composition, such that the ratio of nickel to tungsten is higher in portions of the layer lying closer to the first layer and the ratio of nickel to tungsten is lower in portions of the layer lying closer to the third layer.

In some further embodiments, the electrochromic stack comprises one or more additional layers disposed on the first layer, wherein at least one of the layers is a ceramic layer. For example, in some embodiments, a first gold layer or a first silica layer is disposed on the first layer, and a first indium tin oxide layer is disposed on the first gold layer or the first silica layer. In some such embodiments, the first silica layer is disposed on the first layer, and the first indium tin oxide layer is disposed on the first silica layer. Other layers can also be disposed on the stack or included within the stack. For example, in some embodiments, the first indium tin oxide layer is disposed on an optical substrate. In some embodiments, a first hard coat can be disposed on the first indium tin oxide layer. In some embodiments, a first antireflective coat is disposed on the first hard coat. Other coatings and layers can be included as well.

In some further embodiments, the electrochromic stack comprises one or more additional layers disposed on the third layer, wherein at least one of the layers is a ceramic layer. For example, in some embodiments, a second gold layer or a second silica layer is disposed on the third layer, and a second indium tin oxide layer is disposed on the second gold layer or the second silica layer. In some such embodiments, the second silica layer is disposed on the third layer, and the second indium tin oxide layer is disposed on the second silica layer. Other layers can also be disposed on the stack or included within the stack. For example, in some embodiments, the second indium tin oxide layer is disposed on an optical substrate. In some embodiments, a first hard coat can be disposed on the second indium tin oxide layer. In some embodiments, a first antireflective coat is disposed on the first hard coat. Other coatings and layers can be included as well.

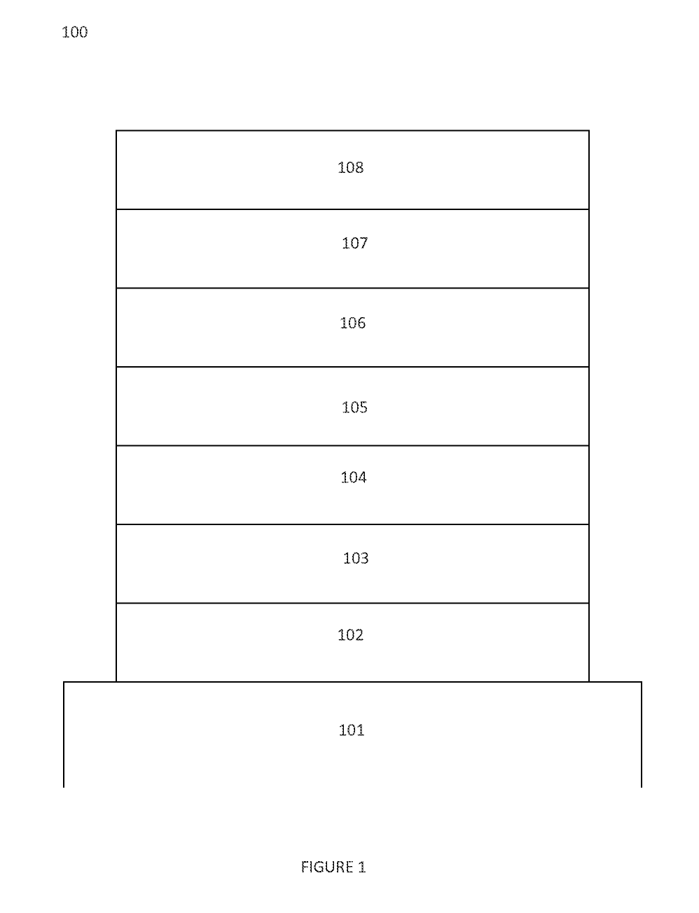

FIG. 1 shows an electrochromic optical system 100 of at least one embodiment of the invention. The figure shows an optical substrate 101 onto which is disposed, in order, an first indium tin oxide layer 102, a first silica layer 103, a nickel (II) oxide layer 104, a nickel oxide and tungsten oxide nanostructured layer 105, a tungsten oxide layer 106, a second silica layer 107, and a second indium tin oxide layer 108.

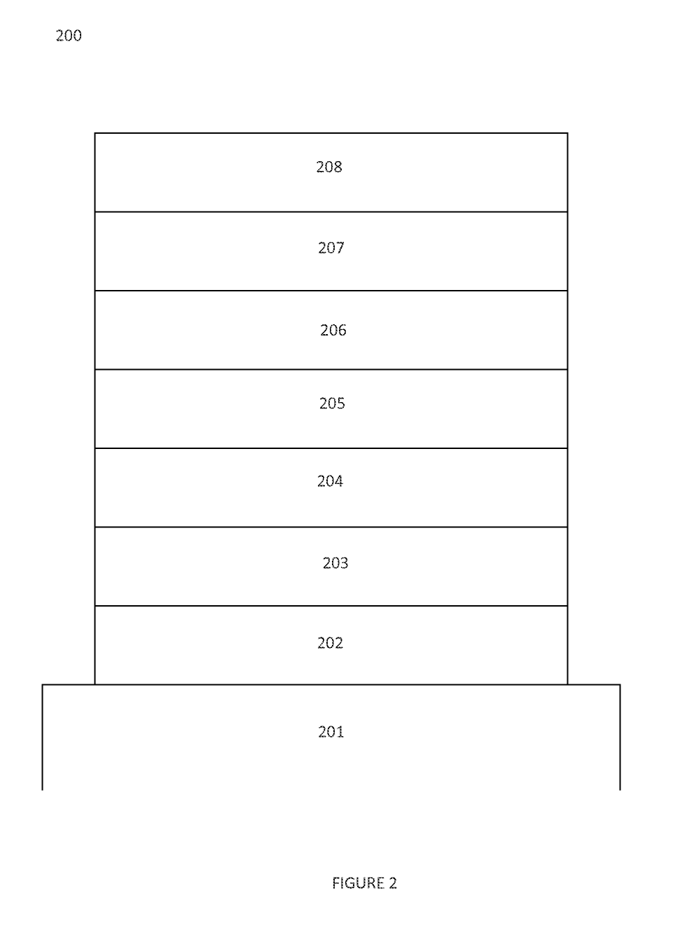

FIG. 2 shows an electrochromic optical system 200 of at least one embodiment of the invention. The figure shows an optical substrate 201 onto which is disposed, in order, an first indium tin oxide layer 202, a first silica layer 203, a tungsten oxide layer 104, a nickel oxide and tungsten oxide nanostructured layer 105, a nickel (II) oxide layer 106, a second silica layer 107, and a second indium tin oxide layer 108.

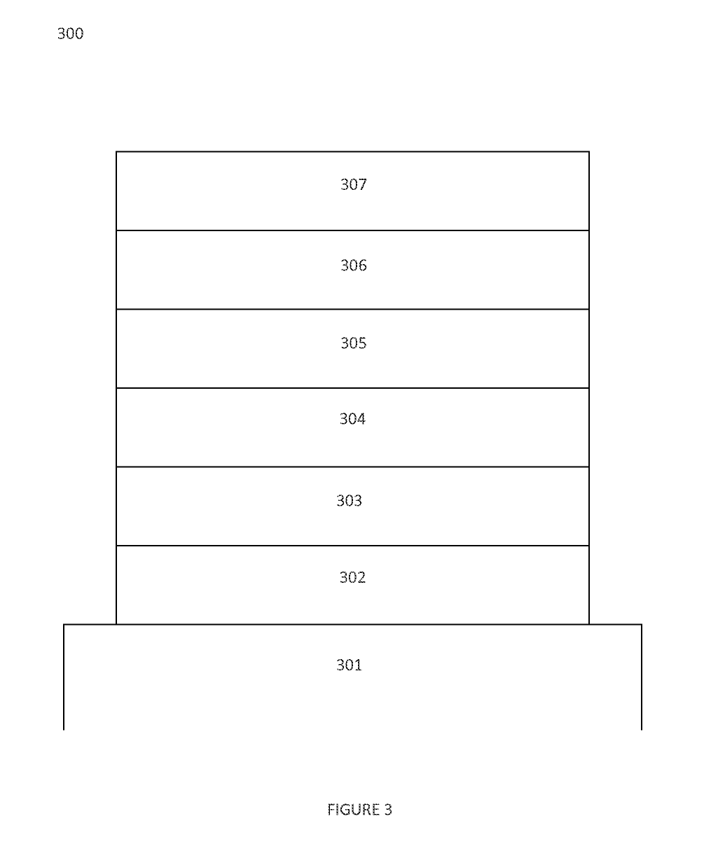

FIG. 3 shows an electrochromic optical system 300 of at least one embodiment of the invention. The figure shows an optical substrate 301 onto which is disposed, in order, an first indium tin oxide layer 302, a nickel (II) oxide layer 303, a nickel oxide and tungsten oxide nanostructured layer 304, a tungsten oxide layer 305, a silica layer 306, and a second indium tin oxide layer 307.

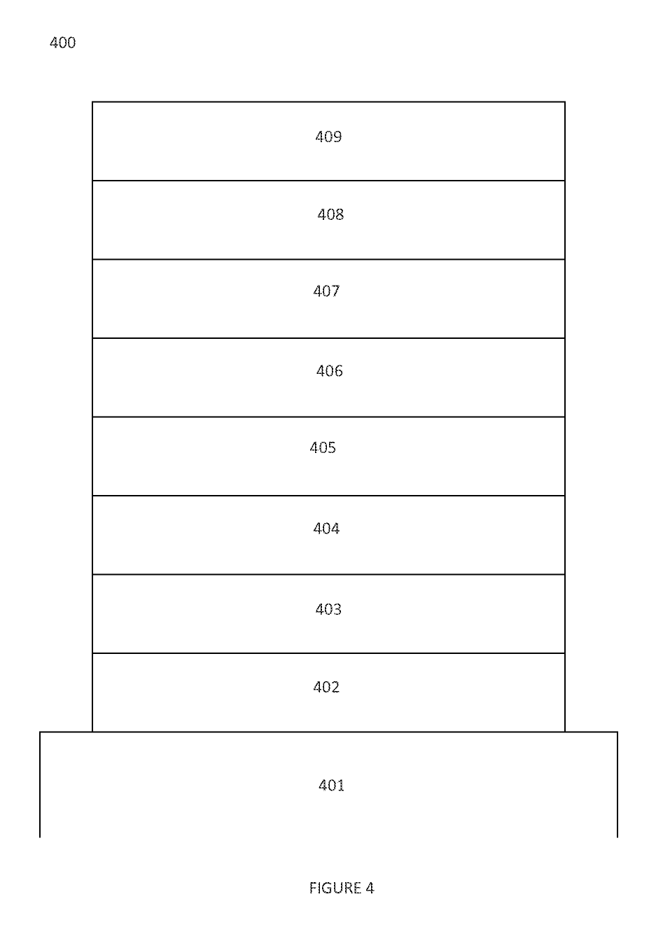

FIG. 4 shows an electrochromic optical system 400 of at least one embodiment of the invention. The figure shows an optical substrate 401 onto which is disposed, in order, an first indium tin oxide layer 402, a first silica layer 403, a nickel (II) oxide layer 404, a nickel oxide and tungsten oxide nanostructured layer 405, a tungsten oxide layer 406, a second silica layer 407, a second indium tin oxide layer 408, and a hard coat 408.

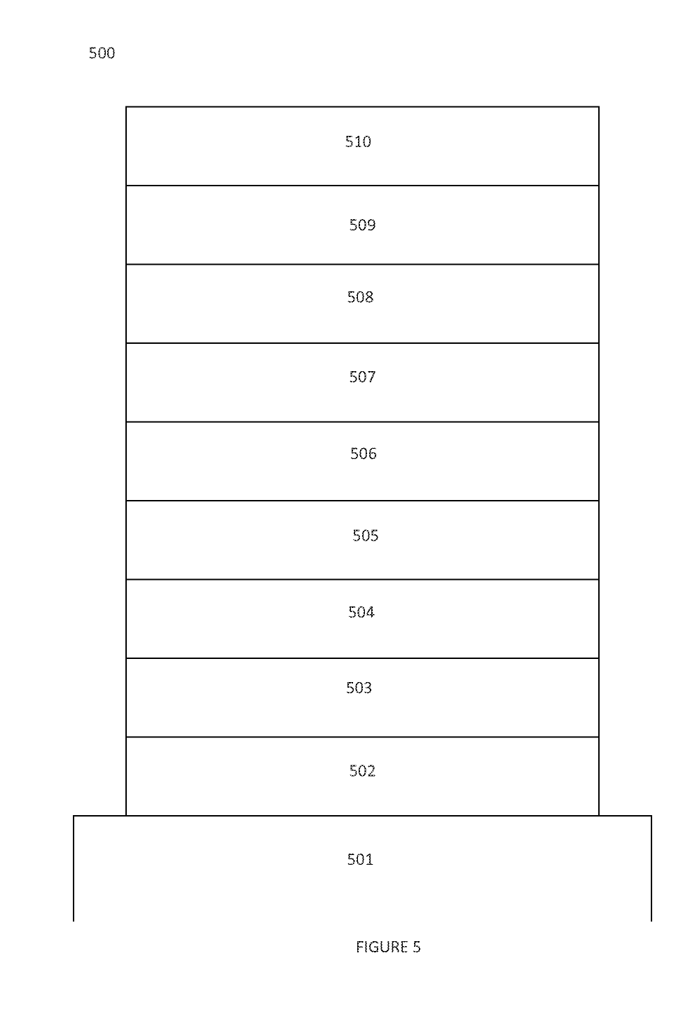

FIG. 5 shows an electrochromic optical system 500 of at least one embodiment of the invention. The figure shows an optical substrate 501 onto which is disposed, in order, an first indium tin oxide layer 502, a first silica layer 503, a nickel (II) oxide layer 504, a nickel oxide and tungsten oxide nanostructured layer 505, a tungsten oxide layer 506, a second silica layer 507, a second indium tin oxide layer 508, a hard coat 508, and an antireflective coat 509.

### Spectacles Comprising an Electrochromic Optical System

In another aspect, the invention provides a pair of spectacles comprising: a frame; and a first lens and a second lens, each of which is disposed in the frame; wherein one or both of the first lens or second lens is an electrochromic optical system, as described in the embodiments above. In some embodiments, the first lens and the second lens are both electrochromic optical systems, as described in the embodiments above.

In some embodiments, the pair of spectacles comprises various features that enable the delivery of an electric potential (and control thereof) to the electrochromic stack. Therefore, in some embodiments, the first lens and second lens comprise various electrical structures, such as wires and contacts, that serve to provide an electric potential to the electrochromic stack. In some embodiments, these wires or contacts are transparent. In some embodiments, the frame includes various wires and contacts adapted to deliver an electric potential to the electrochromic stack on one or both lenses. In some embodiments, the frame comprises a controller that is in electrical communication with the electrochromic stacks in one or both lenses. The controller is adapted to supply an electric potential to the electrochromic stacks (e.g., adapted to activate and/or deactivate the electrochromic stack), and thereby can control the degree of light blocking exhibited by the lenses. The pair of spectacles can also comprise a user input feature that is in electrical communication with the controller. In some embodiments, the user input feature allows the user to indicate his or her intent to activate the electrochromic feature of the lenses. In some embodiments, this input feature is a switch. In some other embodiments, it is a button, such as a physical button or a designated region of a screen, such as an LED or OLED screen. In some other embodiments, the pair of spectacles comprises a photosensor that is in electrical communication with the controller. The pair of spectacles can include any variety of other features, as are known in the art, including the use of electro-active optical structures in the lens, and other such features.

### Method of Securing an Electrochromic Stack to an Optical Substrate

In at least one aspect, the invention relates to a method of disposing one or more electro-chromic layers on an optical substrate, comprising: providing an optical substrate and a glass substrate, the glass substrate having one or more electro-chromic layers disposed on a first surface; and securing the glass substrate to the optical substrate, such that the first surface of the glass substrate faces the optical substrate; wherein the securing step comprises adhering the glass substrate to the optical substrate using an adhesive layer.

The method includes providing an optical substrate (as defined above). In some embodiments, the optical substrate is a lens. In some other embodiments, the optical substrate is a semi-finished lens blank. The optical substrate can be made of any suitable material. In some embodiments, however, it is made of a material that is not physically stable at higher temperatures, e.g., temperatures greater than 100° C., or greater than 120° C., or greater than 130° C., or greater than 140° C. In some such embodiments, the optical substrate is an organic material. In some embodiments, the optical substrate is an organic polymeric material. In some embodiments, the optical substrate comprises a polycarbonate material.

The method also includes providing a glass substrate. As used herein, “glass” refers to an amorphous inorganic solid material. It generally includes a major amount of silicon oxide, and can have minor amounts of other metal oxides, including, but not limited to, oxides of calcium, aluminum, magnesium, and sodium. Other oxides and dopants can be present as well.

One or more electrochromic layers are disposed on the glass substrate. The invention is not limited to any particular type of electrochromic materials. In some embodiments, the electrochromic layers include an electrochromic stack, such as that described in the previous aspects of the invention. In some other embodiments, the electrochromic layers include other electrochromic materials that are known in the art, including, but not limited to, tungsten oxide, nickel (II) oxide, zinc oxide, organic polymers, and certain organic-inorganic hybrid materials (described below). The electrochromic layers can be disposed onto the glass substrate by any methods known in the art. The selection of a method will depend on various factors, including, but not limited to, the identity of the electrochromic materials, the thickness of the layers, and any desired crystalline properties of the materials.

The disposing of the electrochromic layers on the glass substrate permits the electrochromic layers to be processed at temperatures much higher than could be used if the layers were disposed on a less thermally stable material, such as a polymeric material. Therefore, the use of the glass substrate provides greater flexibility in being able to process the electrochromic layers without concerns about damaging the underlying substrate. In some embodiments, the electrochromic layers are disposed onto the glass substrate using one or more bonding steps followed by an annealing step.

The glass substrate can have any suitable thickness. In some embodiments, the glass substrate has a thickness of from 25 to 500 microns, or from 50 to 250 microns, or from 75 to 200 microns.

The method includes securing the glass substrate having the electrochromic layers to the optical substrate. The surface of the glass substrate bearing the electrochromic layer faces the optical substrate. In some embodiments, the facing surfaces of the glass substrate and the optical substrate are curved surfaces. In some embodiments, these two surfaces have substantially the same radius of curvature, meaning that their radii of curvature are within 10%, or within 7%, or within 5% of each other. In some such embodiments, the surface of the optical substrate is a concave surface. In some other such embodiments, the surface of the optical substrate is a convex surface. The securing can be carried out by any suitable means. In some embodiments, the securing comprises using an adhesive.

In some embodiments, the adhesive is selected so as to have a refractive index that is suitable use in combination with the glass substrate and the optical substrate. In embodiments where the glass substrate and the optical substrate have approximately the same index of refraction (e.g., where the optical substrate is another glass substrate), the adhesive is selected so as to have substantially the same index of refraction as that of the two substrate materials, meaning that its index of refraction is no more than 20%, or no more than 15%, or no more than 10%, or no more than 5% different from that of either of the two substrate materials. In embodiments, where the glass substrate and the optical substrate have different indices of refraction, the adhesive can, in some such embodiments, be selected so as to have an index of refraction that lies between that of the two substrate materials. In some such embodiments, the index of refraction of the adhesive lies between 25% and 75%, or between 30% and 70%, or between 35% and 65%, or between 40% and 60%, or between 45% and 55% of the difference between the indices of refraction of the two substrate materials. In some other embodiments, the index of refraction of the adhesive matches that of the optical substrate, meaning that the index of refraction of the adhesive layer is within 25%, or within 20%, or within 15%, or within 10%, or within 5% of that of the optical substrate.

The resulting structure can be used, in some embodiments, as an electrochromic optical system. Therefore, in some embodiments, the optical substrate and/or the glass substrate can comprise various electrical structures, such as wires and contacts, that serve to provide an electric potential to the electrochromic layers. In some embodiments, these wires or contacts are transparent.

The substrates can, in some embodiments, be coated with various coatings in layers, as are known in the art. For example, the glass substrate or the optical substrate can have an antireflective coating or a hard coat.

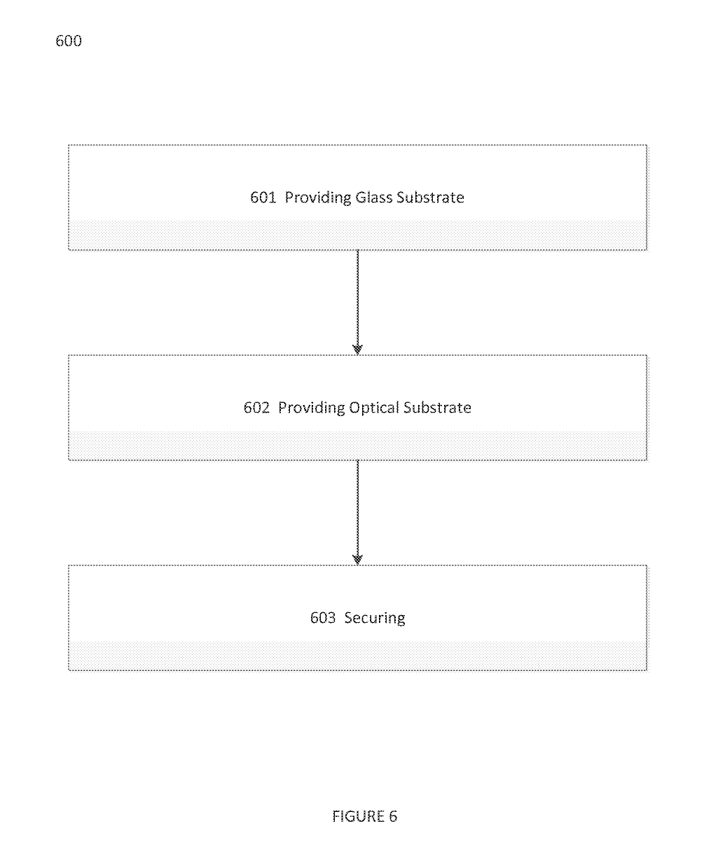

FIG. 6 shows a flow chart for the method of at least one embodiment of the invention. The method 600 includes providing a glass substrate having an electrochromic stack 601, providing an optical substrate, such as a semi-finished lens blank 602, and securing the glass substrate to the optical substrate 603.

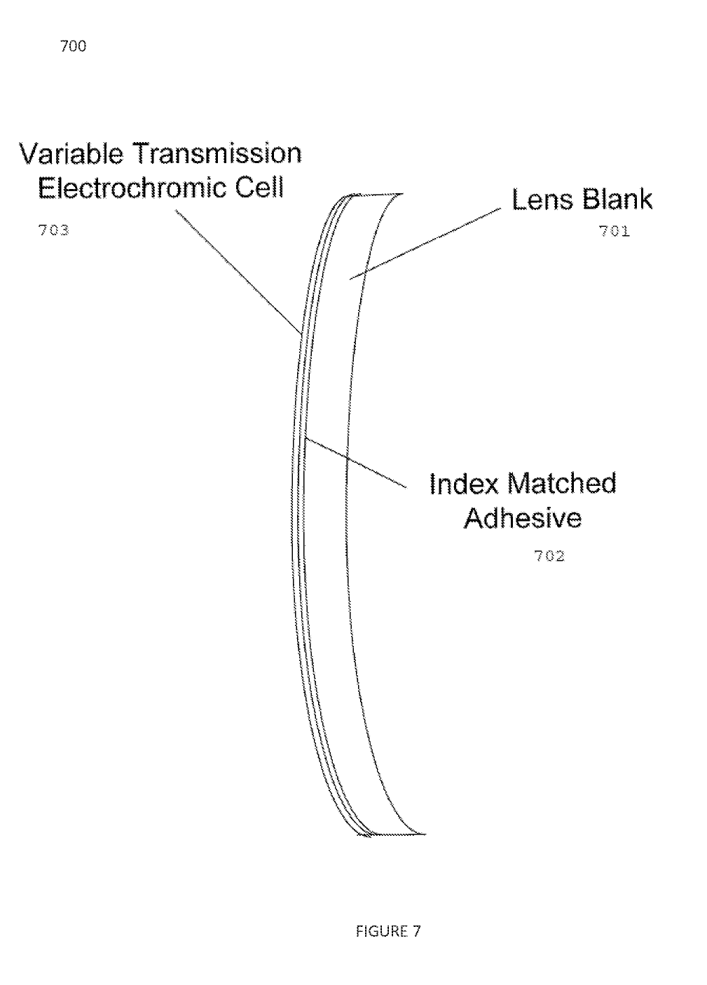

FIG. 7 depicts an electrochromic optical system made according to one embodiment of the invention 700. The figure shows a lens blank 701, an index matched adhesive 702, and a variable transmission electrochromic cell 703.

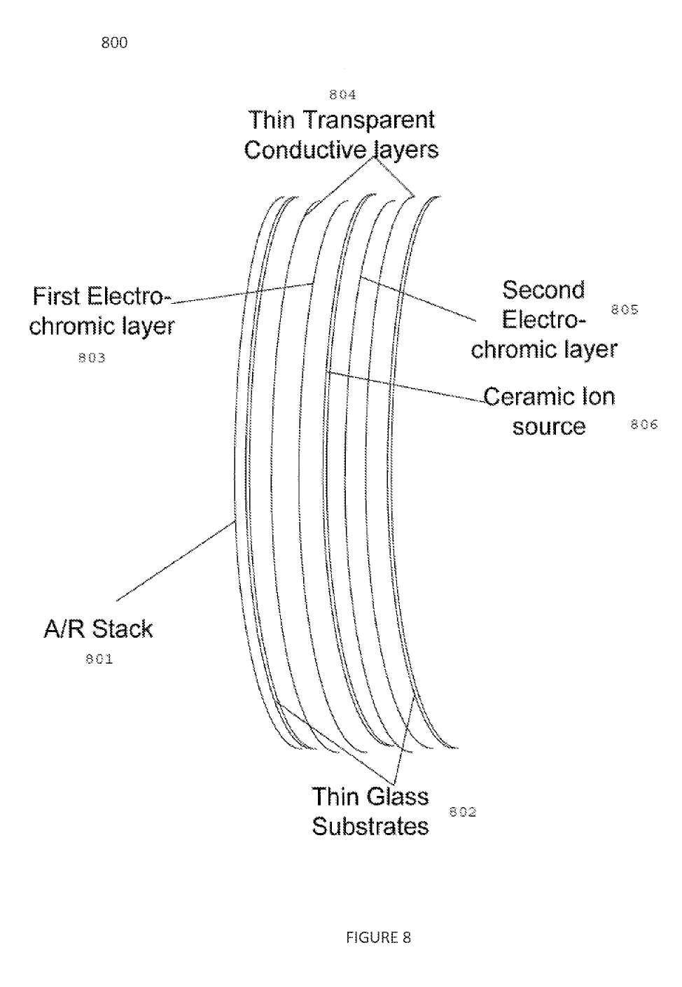

FIG. 8 depicts an electrochromic optical system made according to one embodiment of the invention 800. The figure shows an antireflective stack 801, thin glass substrates 802, a first electrochromic layer 803, this transparent conductive layers 804, a second electrochromic layer 805, and a ceramic ion source 806.

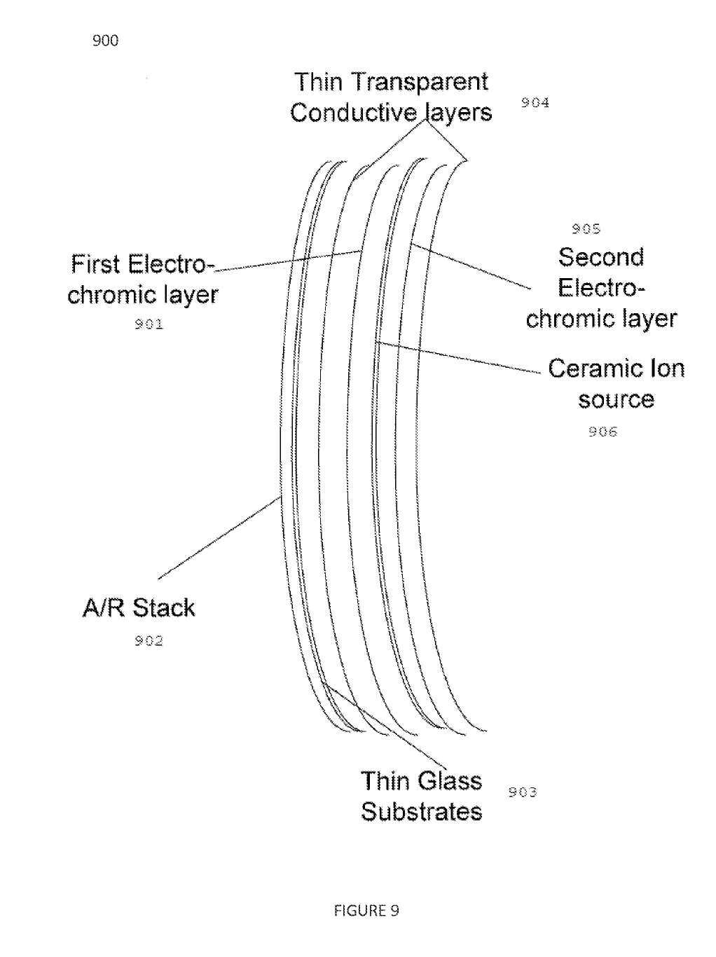

FIG. 9 depicts an electrochromic optical system made according to one embodiment of the invention 900. The figure shows a first electrochromic layer 901, an antireflective stack 902, a thin glass substrate 903, this transparent conductive layers 904, a second electrochromic layer 905, and a ceramic ion source 906.

### Hybrid Electrochromic Materials

In another aspect, the invention provides a hybrid electrochromic film, comprising a nanostructured inorganic film, the film comprising an enhancer compound. As used in this section, the term “nanostructured” has the same meaning as that provided above. In some embodiments, the nanostructured films are also nanoporous films. Such films can be made by any suitable process, including, but not limited to, sol-gel processes.

The nanostructured inorganic film can have any suitable thickness. In some embodiments, the film has a thickness of from 5 to 500 nm, or from 5 to 200 nm, or from 5 to 100 nm, or from 5 to 50 nm.

The nanostructured inorganic film can be made of any suitable inorganic material. In some embodiments, the film comprises a metal oxide. In some such embodiments, the metal oxide is an oxide of tungsten, zirconium, vanadium, molybdenum, iridium, or combinations thereof. In some embodiments, the metal oxide is tungsten oxide. In some other embodiments, the metal oxide is zinc oxide.

The film comprises one or more enhancer compounds. These electrochromic enhancers are compounds that can, in some instances, enhance the coloration efficiency of the electrochromic material and compensate for any undesirable colors in the material or any bleaching that can occur. In some embodiments, the enhancer compounds are organic compounds. In some embodiments, the enhancer compounds are viologens, such as various salts of quaternized 4,4-bypyridine. In some other embodiments, the enhancer compounds are metal coordination complexes, such as transition metal polypyridyl complexes, metallophthalo-cyanines, polymeric viologens, and the like. In some other embodiments, the enhancer compounds are dye compounds, such as Prussian blue. In some other embodiments, the enhancer compounds are conductive polymers, such as poly(3,4-ethylenedioxythiophene) poly(styrene sulfonate) (PEDOT:PSS), polyanilines, or polypyrroles. Or, in some other embodiments, the enhancer compounds can be any combination of any of the above classes of compounds.

The enhancer compound can be introduced to the inorganic layer in any suitable manner consistent with the invention. Suitable means of effecting such introduction include, but are not limited to, doping, adsorbing, absorbing, or by adding an additional the enhancer compounds as an additional thin film immediately adjacent to the inorganic layer. Such thin films can be deposited by any suitable coating process, including, but not limited to, spin coating, spraying, die slot coating, and gravure coating.

In some embodiments, the electrochromic film is disposed (e.g., deposited) on a thin flexible substrate. Suitable substrate materials include, but are not limited to, plastics, such as TAC, PSU, PPSU, and PEEK, and glass, such as Corning WILLLOW glass.

The invention is not limited to any particular arrangement of the hybrid material in an electrochromic stack. Further, in some embodiments, additional layers and materials can be included, for example, to change performance characteristics. Such changes include, altering the color of the stack, whether in the “bleached” or “colored” state of the device, improve the stability of the material, and improve the switching speed.

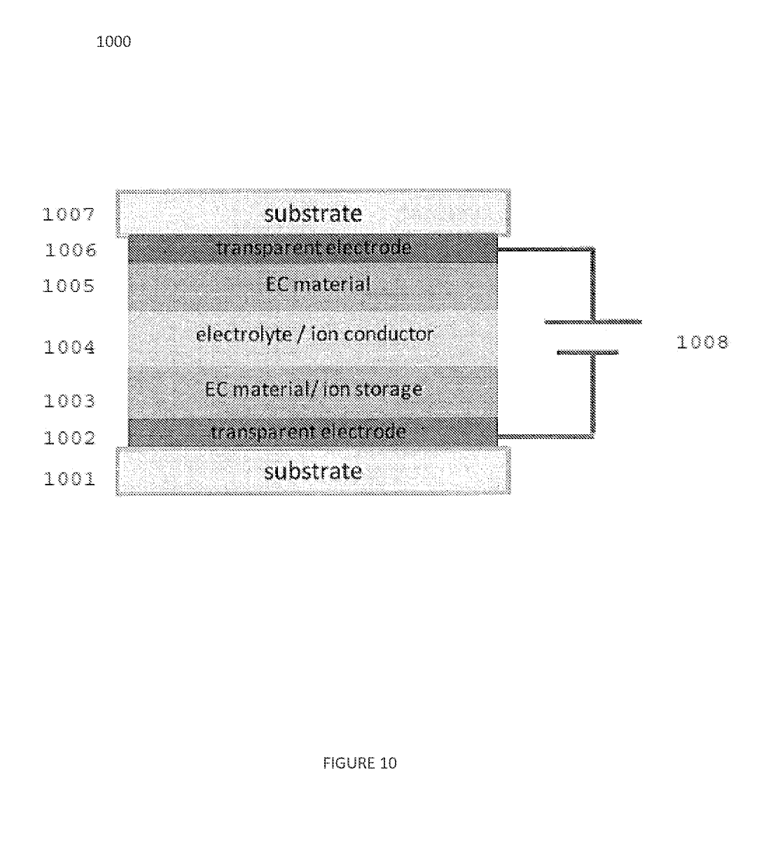

FIG. 10 shows an example of an electrochromic stack 1000 according to at least one embodiment of the invention. The stack includes a first substrate 1001, a first transparent electrode 1002, a electrochromic/ion storage material (hybrid inorganic-organic material) 1003, an electrolyte/ion conductor 1004, an electrochromic material 1005, a second transparent electrode 1006, a second substrate 1007, and a source of an electric potential 1008.

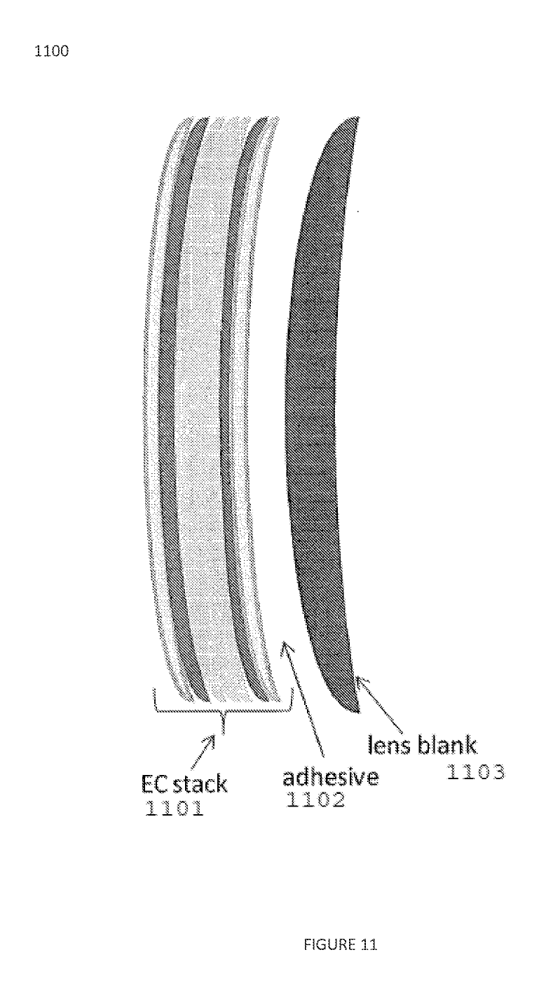

FIG. 11 shows a lens having an electrochromic stack according to at least one embodiment of the invention 1100. The Figure shows an electrochromic stack 1101, an adhesive layer 1102, and a lens blank 1103.

1. An electro-chromic optical system, comprising:
an optical substrate; and
an electro-chromic stack disposed on the optical substrate, wherein the electro-chromic stack comprises at least five ceramic layers disposed successively on each other; wherein each of the at least five layers has a thickness of 5 to 1000 nm, and at least one of the at least five ceramic layers comprises a nanostructured material.

2. The electro-chromic optical system of claim 1, wherein each of the at least five ceramic layers is an oxide.

3. The electro-chromic optical system of claim 1, wherein at least one of the at least five layers comprises a nanostructured material, which is an oxide of tungsten, nickel, iridium, molybdenum, or a combination thereof

4. The electro-chromic optical system of claim 3, wherein the nanostructured material is an oxide of tungsten, nickel, or a combination thereof.

5. The electro-chromic optical system of claim 3, wherein the electro-chromic stack comprises:
a first layer composed of nickel oxide;
a second layer composed of a combination of nickel oxide and tungsten oxide, and which is disposed on the first layer; and
a third layer composed of tungsten oxide, which is disposed on the second layer.

6. The electro-chromic optical system of claim 5, wherein at least one of the first layer, the second layer, or the third layer comprises a nanostructured material.

7. The electro-chromic optical system of claim 6, wherein the second layer comprises a nanostructured material.

8. The electro-chromic optical system of claim 6, wherein the second layer displays a gradient in composition, such that the ratio of nickel to tungsten is higher in portions of the layer lying closer to the first layer and the ratio of nickel to tungsten is lower in portions of the layer lying closer to the third layer.

9. The electro-chromic optical system of claim 1, wherein the nanostructured material is a nanoporous material.

10. The electro-chromic optical system of claim 5, wherein the electro-chromic stack comprises one or more additional layers disposed on the first layer, wherein at least one of the layers is a ceramic layer.

11. The electro-chromic optical system of claim 5, wherein a first gold layer or a first silica layer is disposed on the first layer, and a first indium tin oxide layer is disposed on the first gold layer or the first silica layer.

12. The electro-chromic optical system of claim 11, wherein a first silica layer is disposed on the first layer, and a first indium tin oxide layer is disposed on the first silica layer.

13. The electro-chromic optical system of claim 5, wherein the electro-chromic stack comprises one or more additional layers disposed on the third layer, wherein at least one of the layers is a ceramic layer.

14. The electro-chromic optical system of claim 5, wherein a second gold layer or a second silica layer is disposed on the third layer, and a second indium tin oxide layer is disposed on the second gold layer or the second silica layer.

15. The electro-chromic optical system of claim 14, wherein a second silica layer is disposed on the third layer, and a second indium tin oxide layer is disposed on the second silica layer.

16. The electro-chromic optical system of claim 11, wherein the first indium tin oxide layer is disposed on an optical substrate.

17. The electro-chromic optical system of claim 11, wherein a first hard coat is disposed on the first indium tin oxide layer.

18. The electro-chromic optical system of claim 17, wherein a first antireflective coat is disposed on the first hard coat.

19. The electro-chromic optical system of claim 14, wherein the second indium tin oxide layer is disposed on an optical substrate.

20. The electro-chromic optical system of claim 14, wherein a first hard coat is disposed on the second indium tin oxide layer.

21. The electro-chromic optical system of claim 20, wherein a first antireflective coat is disposed on the first hard coat.

22. The electro-chromic optical system of claim 1, further comprising:
a frame; and
a first lens and a second lens, each of which is disposed in the frame;
wherein the first lens includes the optical substrate.

23. (canceled)

24. The pair of spectacles of claim 22, further comprising a controller adapted to activate or deactivate the electro-chromic stack.

25. The pair of spectacles of claim 24, further comprising a photosensor in electrical communication with the controller.

26. A method of disposing one or more electro-chromic layers on an optical substrate, comprising:
providing an optical substrate and a glass substrate, the glass substrate having one or more electro-chromic layers disposed on a first surface;
securing the glass substrate to the optical substrate, such that the first surface of the glass substrate faces the optical substrate;
wherein the securing step comprises adhering the glass substrate to the optical substrate using an adhesive layer, the adhesive layer having an index of refraction matching that of the optical substrate.

27. The method of claim 26, wherein the glass substrate has a thickness of 25 to 500 μm.

28. The method of claim 26, wherein the one or more electro-chromic layers comprises a stack of at least five layers.

29. The method of 28, wherein the layers of the stack comprise metal oxide layers, organic polymers, or hybrid layers consisting of a metal oxide and adsorbed organic molecules that undergo reversible redox electron transfer.

30. (canceled)

31. A hybrid electro-chromic film, comprising a nanostructured inorganic film, the film comprising an enhancer compound;
wherein the nanostructured inorganic film comprises a metal oxide; and
wherein the enhancer compound is a viologen, a conductive polymer, a metal coordination complex, or Prussian blue.

32. The film of claim 31, wherein the nanostructured film comprises an oxide of tungsten, zirconium, vanadium, molybdenum, iridium, or combinations thereof.

33. The film of claim 31, wherein the enhancer compound is a dopant in the nanostructured inorganic film.

34. The film of claim 31, wherein the enhancer compound is absorbed or adsorbed onto the nanostructured inorganic film.

35. The film of claim 31, wherein the enhancer compound is a separate sub layer disposed onto a metal oxide layer.

36. (canceled)

37. The electro-chromic optical system of claims 1, wherein each of the at least five layers has a thickness of 5 to 200 nm.
